(19) United States
(12) Patent Application Publication
(10) Pub. No.: US 2003/0065864 A1
(43) Pub. Date: Apr. 3, 2003

(54) System and method supporting remote data processing system management

(75) Inventor: Herbert A. Hollinger, Pflugerville, TX (US)

Correspondence Address: Michael R. Barre, Baker Botts L.L.P., One Shell Plaza, 910 Louisiana, Houston, TX, 77002-4995, US

(73) Assignee: DELL PRODUCTS L.P.

(21) Appl. No.: 09/970,229

(22) Filed: Oct. 3, 2001

(51) Int. Cl. G06F 13/38

(52) U.S. Cl. 710/305

(57) ABSTRACT

A remotely manageable data processing system includes a video spoof subsystem that simulates a video adapter. The data processing system also includes a processing core in communication with the video spoof subsystem. The processing core transmits video data to the video spoof subsystem, and the video spoof subsystem translates the video data into video output. In addition, the data processing system includes a packet engine that receives the video output from the video spoof subsystem, generates network packets based on the video output, and transmits the network packets to a remote workstation. The data processing system thus uses spoofing to support remote video. In an example embodiment, the video data is digital video data, the data processing system includes no video adapter, and the data processing system does not convert the digital video data to analog.

### TECHNICAL FIELD

The present disclosure relates in general to data processing systems. In particular, the present disclosure involves facilities and methods for remotely managing computers such as servers.

### BACKGROUND

Computer networks typically require monitoring and maintenance. For example, network administrators typically monitor conditions such as workload and operational status of individual servers within the network. Technologies have recently been developed which, under certain circumstances, allow some aspects of server status to be monitored and controlled remotely. For example, if a server is operational and executing an operating system (OS), virtual-terminal software that runs on top of the OS can be used to manage and configure the server from a remote workstation.

A disadvantage of typical virtual-terminal software is that such software supports remote communications only so long as the OS is loaded and successfully executing on the server. However, network administrators frequently desire to interact with servers that are not running an OS, including servers that are in a stage of the startup sequence before the OS is loaded and servers that have suffered OS errors such lock ups and crashes. When it becomes necessary to interact with a server that lacks an active OS, a network administrator may resort to local management. For example, the network administer may travel to the site of the server and interact directly with the server using a local keyboard, a local mouse, and a local display device. For instance, the network administrator may use local devices to watch the server boot, to configure the basic input/output system (BIOS), and to run diagnostics in a pre-OS process. The local keyboard, mouse, and display device may be connected directly into connectors in the server, or, if the server is mounted in a rack with other servers, the local keyboard, mouse, and display device may be connected to a switchbox that serves the entire rack. Alternatively, a separate out-of-band console may be utilized, for example via a serial connection. After the OS is loaded, the virtual-terminal software may be used to further administer the server.

A remote management technology that can be used to address the disadvantage of requiring an active OS is described in U.S. Pat. No. 6,098,143, assigned to Compaq Computer Corporation (the '143 patent). The '143 patent describes a server management board (SMB) that connects to a server that has a host central processing unit (CPU) and a host video adapter. The SMB includes another microprocessor and another video adapter, along with a network interface controller (NIC), and the SMB uses a technique known as “snooping” to retrieve video data.

To snoop is to use one component, such as a snoop circuit, to obtain data that is actually directed to or stored in a different component, such as a video adapter. The component that is being snooped may be referred to as the visible component, since that component is known (i.e., apparent) to the original data source. For instance, if a CPU is sending video data to a video adapter and, unbeknownst to the CPU, a snoop component is obtaining a copy of that video data, the video adapter would be considered visible. By contrast, the snoop component would be considered hidden. The act of snooping does not prevent the data from reaching the visible component or otherwise interfere with the normal operation of the system.

In the '143 patent, when the server is booted, the server detects the video adapter on the server management board (i.e., the SMB video adapter) and disables the host video adapter. A video snoop circuit subsequently reads video data from a bus destined for the SMB video adapter, and that video data is saved for remote retrieval in the event the server loses power. In an alternative embodiment, no video adapter is provided on the SMB, and the SMB snoops the video data from a bus destined for the host video adapter. Video adapters may also be referred to as video controllers.

A disadvantage of the approach taught by the '143 patent is the significant cost associated with deploying a server that implements the teachings of that patent. As recognized by the present invention, there remains a need for less costly systems and methods for remotely managing data processing systems.

### SUMMARY

The present disclosure relates to a remotely manageable data processing system with a video spoof subsystem that simulates a video adapter. The data processing system also includes a processing core in communication with the video spoof subsystem. The processing core transmits video data to the video spoof subsystem, and the video spoof subsystem translates the video data into video output. In addition, the data processing system includes a packet engine that receives the video output from the video spoof subsystem, generates network packets based on the video output, and transmits the network packets to a remote workstation. The data processing system thus uses spoofing to support remote video.

The video spoof subsystem may include an accelerator that converts the video data from the processing core into bitmaps and a video memory module that receives the bitmaps from the accelerator. The video spoof subsystem may be implemented as part of a remote management subsystem, and the remote management subsystem may be embedded on the motherboard of the data processing system. The remote management subsystem may also include a mouse/keyboard (M/K) spoof subsystem that simulates a local keyboard and a local mouse for remote management.

In one embodiment, the video data is digital video data, the data processing system includes no video adapter, and the data processing system does not convert the digital video data to analog. In another embodiment, the data processing system includes a service processor, and the network packets sometimes carry output from the service processor and sometimes carry output from the processing core.

### BRIEF DESCRIPTION OF THE DRAWINGS

The present disclosure and its numerous objects, features, and advantages may be better understood by reference to the following description of an illustrative embodiment and the accompanying drawings, in which:

FIG. 1 presents a high level block diagram of an example embodiment of a distributed computing system that includes a remotely manageable server;

FIG. 2 presents a more detailed block diagram of the server from FIG. 1;

FIG. 3 is a flowchart of an exemplary process for supporting remote manageability in the server of FIG. 1; and

FIG. 4 is a flowchart of an exemplary process for remotely interacting with the server of FIG. 1.

### DETAILED DESCRIPTION

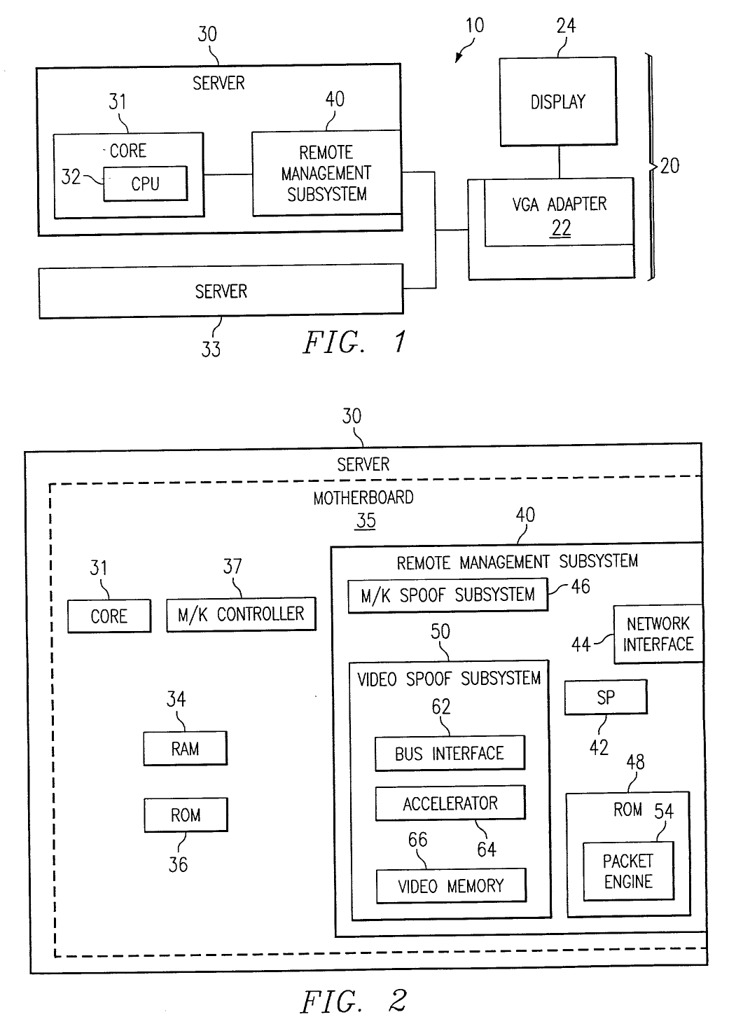

The block diagram of FIG. 1 depicts a computer network 10 that includes a remotely manageable server 30 and a workstation 20 according to an example embodiment of the present invention. Specifically, server 30 is a data processing system that includes a remote management subsystem (RMS) 40, as well as a processing core 31 with at least one central processing unit (CPU) 32. As described in greater detail below, RMS 40 facilitates management of server 30 from remote workstations, such as workstation 20. Workstation 20 includes a network interface, a video adapter 22, and a display 24.

Computer network 10 may also be referred to as a distributed computing system 10, and distributed computing system 10 may include additional servers, such as server 33. In the example embodiment, server 33 also includes an RMS and is manageable from workstation 20. Computer network 10 may also include addition workstations that can be used to remotely manage servers 30 and 33.

Referring now to FIG. 2, in the example embodiment, an embedded implementation is depicted, in which processing core 31 and RMS 40 are mounted on a motherboard 35 in server 30. Numerous other components are also connected to motherboard 35, including storage media, such as random access memory (RAM) 34 and ROM 36, as well as a mouse/keyboard (M/K) controller 37, such as an i8042 controller from INTEL Corporation.

RMS 40 includes a service processor (SP) 42 and a ROM 48. ROM 48 contains initialization instructions and system management instructions to be executed by SP 42. RMS 40 also includes a network interface 44 for communicating with other computers in distributed computing system 10. RMS 40 also includes an M/K spoof subsystem 46 and a video spoof subsystem 50.

To spoof is to simulate an expected component or subsystem, such as a video adapter, for communications with a base component, such a CPU. Thus, in spoofing, the spoof subsystem is visible to the base component, and the base component “believes” that the spoof subsystem is actually the expected target component. In snooping, by contrast, the snoop subsystem is not visible to the base component. By analogy, if person C were listening surreptitiously to a telephone conversation between person A and person B, person C would be snooping. However, if person A were attempting to call person B, but person C answers the call and pretends to be person B, person C would be spoofing.

In the example embodiment, M/K controller 37 is considered a base component, and M/K spoof subsystem 46 interacts with M/K controller 37, fooling a host boot process of server 30 into operating as if a mouse and keyboard were directly connected to server 30, even if no mouse or keyboard is present locally. After the boot process, M/K spoof subsystem 46 continues to interact with M/K controller 37, fooling the OS into operating as if a mouse and keyboard were directly connected to server 30.

To perform the spoofing, M/K spoof subsystem 46 intercepts commands from M/K controller 37, in and after the discovery portion of the boot process, before the commands are sent to an actual M/K device. Also, M/K spoof subsystem 46 responds to any device-discovery queries, whether or not a local device or a remote workstation is attached. M/K spoof subsystem 46 also receives and saves programmable device parameters during the discovery process. When workstation 20 is communicating with server 30, M/K spoof subsystem 46 generates standard M/K input, such as keyboard scan codes, for M/K controller 37, based on user input received from workstation 20. When a local input device is connected, M/K spoof subsystem 46 multiplexes the remote and local device I/O to M/K controller 37. M/K spoof subsystem 46 also uses the programmable device parameters that were saved in the discovery process to translate the commands from M/K controller 37, where appropriate. M/K spoof subsystem 46 thus spoofs local input devices for pre-OS and post-OS processes in server 30.

Similarly, video spoof subsystem 50 interacts with processing core 31, fooling processing core 31 into operating as if a video adapter were directly connected to server 30. As part of the initialization process, server 30 searches for a video BIOS extension to load into RAM 34, and video spoof subsystem 50 supplies that video BIOS extension. When processing core 31 subsequently issues standardized video commands, such as video commands for text mode and video commands for low resolution video, an accelerator 64 in video spoof subsystem 50 accepts those commands in a manner that is compatible with the standard. To support non-standardized video modes, such as high-resolution video, accelerator 64 impersonates a proprietary video adapter in order to communicate properly with a corresponding video driver on the host OS.

Furthermore, in order to realize benefits such as reduced costs, server 30 is not provided with any video adapters. Instead, video spoof subsystem 50 converts video data from processing core 31 into network packets and transmits the network packets to workstation 20. The video adapter and display of workstation 20 are then used to present the video data.

In particular, video spoof subsystem 50 includes a bus interface 62, accelerator 64, and a video memory 66. However, unlike video adapters, which include random access memory digital-analog converters (RAMDACs) that convert digital bitmaps from video memory into analog signal for transmission to a display, video spoof subsystem 50 does not include a RAMDAC. Video spoof subsystem 50 receives video data via bus interface 62, but video spoof subsystem 50 does not convert the video data into analog form for presentation on a display. Rather, the video data is converted into network packets, such as ATM cells or IP packets, for transmission via network interface 44 to workstation 20.

Bus interface 62 receives data from processing core 31 via one or more communication paths, such as a Peripheral Component Interconnect (PCI) bus, an Advanced Graphics Port (AGP) bus, etc. The communication path or paths monitored for video data may be referred to collectively as a video bus.

In the example embodiment, the conversion of video data into network packets is performed by a set of instructions executing on SP 42. That set of instructions is known as a packet engine 54, and packet engine 54 may reside on ROM 48. Thus, according to the example embodiment, the video data from server 30 is converted into an analog form only after it is received by workstation 20.

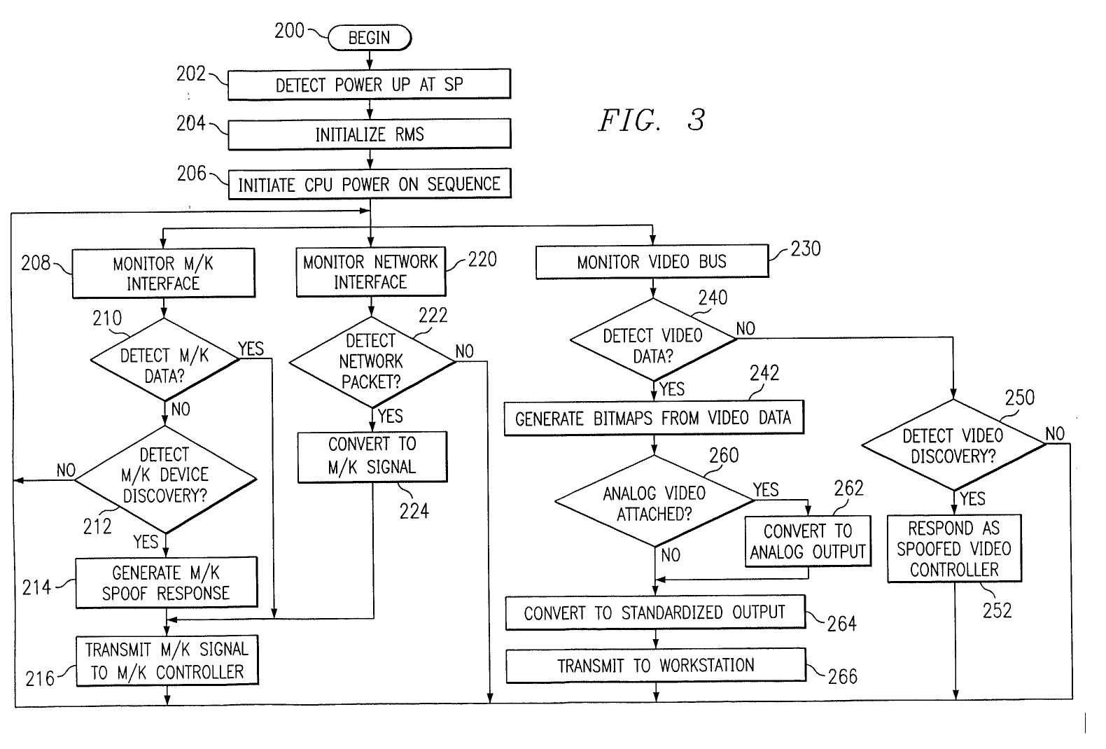

With reference now to FIG. 3, an example embodiment of a process for remotely managing a data processing system such as server 30 begins at block 200 with server 30 in a powered off state. Block 202 then depicts SP 42 detecting that server 30 is being powered on. In response, boot instructions from ROM 48 initialize RMS 40 and initiate a power on sequence for processing core 31, as shown at blocks 204 and 206.

As indicated at blocks 208, 220, and 230, RMS 40 then begins monitoring M/K controller 37, network interface 44, and bus interface 62. As depicted at blocks 210 and 216, if M/K spoof subsystem 46 detects input data from a local mouse or keyboard, M/K spoof subsystem 46 forwards that input data to M/K controller 37. As shown at block 212, if no such input data is detected, M/K spoof subsystem 46 determines whether server 30 is performing M/K device discovery, for example as part of a boot process or in response to a change in the device configuration of server 30. If so, M/K spoof subsystem 46 generates the appropriate response or responses to spoof/simulate local mouse and keyboard devices, as indicated at block 214, and transmits the response/responses to M/K controller 37, as indicated at block 216. RMS 40 then continues to monitor M/K controller 37, network interface 44, and bus interface 62, as indicated by the arrow returning to above block 208.

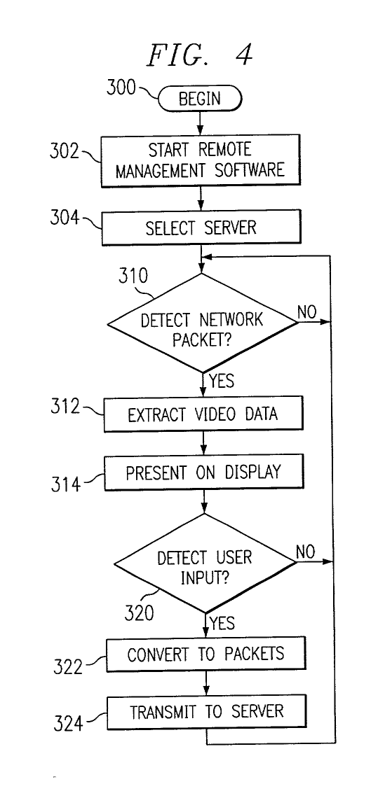

As depicted at blocks 220 and 222, RMS 40 monitors network interface 44 for network packets containing user input for server 30. For instance, as described below with reference to FIG. 4, workstation 20 may send network packets with M/K data to server 30. When such a packet is received, RMS 40 converts the data from the packets into M/K signals and transmits the M/K signals to M/K controller 37, as illustrated by blocks 224 and 216. Consequently, server 30 processes the user input as if it had been received from a mouse or keyboard connected directly to server 30. As indicated by the arrow returning to above block 208, RMS 40 then continues to monitor M/K controller 37, network interface 44, and bus interface 62.

As shown at blocks 230 and 240, RMS 40 also monitors the video bus in server 30 for video data transmitted by processing core 31 or SP 42. RMS 40 receives the video data via bus interface 62. As indicated at block 242, if video data is detected, accelerator 64 converts the video data into bitmaps, which are stored in video memory module 66. In addition, as shown at blocks 260 and 262, if server 30 includes an analog video subsystem, the analog video subsystem converts the bitmaps into analog signals for driving a local display device.

RMS 40 then converts the bitmaps into standardized output for transmission to workstation 20. Specifically, as shown at blocks 264 and 266, packet engine 54 generates network packets encoding those bitmaps and then transmits the network packets to workstation 20 via network interface 44.

In the example embodiment, the bitmaps are encoded according to a platform-independent application-layer protocol such as the Independent Computing Architecture (ICA) or Remote Desktop Protocol (RDP) protocols. In an alternative embodiment, the bitmaps are encoded according to a non-proprietary (i.e., open) application-layer protocol such as the Virtual Network Computing (VNC) protocol. In addition, server 30 uses a network protocol such as Transmission Control Protocol/Internet Protocol (TCP/IP) for transporting the packets to workstation 20. Consequently, RMS 40 allows server 30 to be remotely managed from many different kinds of workstations running many different kinds of remote management packages. After the network packets are transmitted to workstation 20, the process returns to blocks 208, 220, and 230, as described above. RMS 40 then continues to process M/K network packets, as well as local input and video data, as described above. A network administrator at workstation 20 may therefore see output from server 30 and send input data to server 30 as though the administrator were at the site of server 30 and using a local keyboard, mouse, and display.

Referring now to FIG. 4, an example process for managing server 30 from workstation 20 begins at block 300 with an individual such as a network administrator situated at workstation 20. As shown at block 302, the individual then starts remote management software such as VNC executing on workstation 20. Using the remote management software, the individual the selects server 30 for management, as depicted at block 304.

As shown at block 310, workstation 20 then monitors a network connection of workstation 20 to receive packets from server 30. If any packets are received, workstation 20 extracts the video data from the packets and uses VGA adapter 22 and display 24 to present the extracted video data, as indicated at block 312 and 314. Workstation 20 thus displays output reflecting the operating condition of server 30.

In addition, as depicted at block 320, the remote management software receives user input such as M/K input for server 30 from the individual. In response to receiving input for server 30, the remote management software encodes the input in network packets and transmits the network packets to server 30, as shown at block 322 and 324. In the example embodiment, workstation 20 encodes the input using the same application-layer and network protocols as those used by server 30. The process then returns to block 310 with workstation 20 continuing to process video data packets and user input as described above.

In conclusion, as has been described, the example embodiment concerns a remotely-manageable server that provides video data for a remote workstation even though the server includes no video adapter. Specifically, video data from the processing core and/or the service processor is not converted into analog form in the server. The video data is converted into an analog signal only after the video data has been received by the remote workstation. Since the remote management subsystem eliminates the need for a local video adapter, production costs for the server are reduced, relative to similar servers with video adapters, without adversely affecting remote manageability.

Moreover, the server of the example embodiment can be remotely managed via remote management software that uses graphical interfaces and is not limited to textbased interfaces such as command line interfaces (CLIs). Furthermore, the remote management subsystem fully supports pre-OS remote management. That is, full remote management capabilities are provided whether or not the server has booted to the OS. Accordingly, the remote management subsystem provides full functionality regardless of the type of OS to be used by the server. In addition, communications with the server are not limited to a single administrator at a particular keyboard. Instead, multiple administrators can interact with the server substantially simultaneously from different remote locations. Additionally, communication lines between the server and any remote input and output devices need no custom configuration but may simply use conventional network lines. Furthermore, a single connection path can be used for both pre-OS and post-OS administration of the server.

Although the present invention has been described with reference to an example embodiment, those with ordinary skill in the art will understand that numerous variations of the example embodiment could be practiced without departing from the scope of the present disclosure. For example, the remote management subsystem is embedded on the server motherboard in the example embodiment, in alternative embodiments, some or all of the components of the remote management subsystem could be implemented on one or more adapter cards to be connected to the server motherboard. In alternative embodiments that support both local and remote management, the server may also include a video adapter. The video adapter, however, may be hidden from the processing core and service processor. That is, the processing core and service processor may actually communicate the video data to the video spoof subsystem, with the video spoof subsystem then forwarding the video data to the video adapter. Likewise, although local input devices may be connected to the server, those devices may be hidden, with the M/K controller communicating with the M/K spoof subsystem as if the M/K spoof subsystem were a local mouse and/or keyboard.

Furthermore, the modules and components depicted within the server in the example embodiment represent functional elements that are reasonably self-contained so that each can be designed, constructed, or updated substantially independently of the others. In alternative embodiments, however, it should be understood that the components may be implemented as hardware, software, or combinations of hardware and software for providing the functionality described and illustrated herein.

Therefore, the present invention is not limited to the specifically disclosed embodiments but is defined by the following claims.

What is claimed is:

1. A remotely manageable data processing system, comprising:
a video spoof subsystem that simulates a video adapter;
a processing core in communication with the video spoof subsystem, wherein the processing core transmits video data to the video spoof subsystem, and the video spoof subsystem translates the video data into video output; and
a packet engine that receives the video output from the video spoof subsystem, generates network packets based on the video output, and transmits the network packets to a remote workstation, such that the remotely manageable data processing system uses spoofing to support remote video.

2. The remotely manageable data processing system of claim 1, wherein the video spoof subsystem comprises:
an accelerator, in communication with the processing core, that converts the video data from the processing core into bitmaps; and
a video memory module, in communication with the accelerator, that receives the bitmaps from the accelerator; and
wherein the video output from the video spoof subsystem comprises the bitmaps.

3. The remotely manageable data processing system of claim 1, further comprising:
a service processor in communication with the processing core;
wherein the network packets comprise packets with output from the service processor and packets with output from the processing core.

4. The remotely manageable data processing system of claim 1, further comprising:
a motherboard that includes the processing core; and
an embedded remote management subsystem that includes the video spoof subsystem and the packet engine.

5. The remotely manageable data processing system of claim 1, further comprising:
a motherboard that includes the processing core;
an adapter card in communication with the motherboard; and
a remote management subsystem on the adapter card that includes the video spoof subsystem and the packet engine.

6. The remotely manageable data processing system of claim 1, further comprising:
a mouse/keyboard (M/K) spoof subsystem in communication with the packet engine and the processing core; and
a remote management subsystem that includes the video spoof subsystem, the packet engine, and the M/K spoof subsystem;
wherein the M/K spoof subsystem receives user input from the remote workstation via incoming network packets; and
wherein the M/K spoof subsystem converts the user input into standard M/K input for the remotely manageable data processing system.

7. The remotely manageable data processing system of claim 1, further comprising:
a non-volatile memory that contains control logic for executing a basic input/output system (BIOS) initialization process; and
a remote management subsystem that includes the video spoof subsystem and the packet engine;
wherein the remote management subsystem allows the remotely manageable data processing system to communicate with the remote workstation before the remotely manageable data processing system has completed the BIOS initialization process.

8. The remotely manageable data processing system of claim 1, wherein the video spoof subsystem receives the video data from the processing core via an interface selected from the group consisting of:
and advanced graphics port (AGP) bus; and
a Peripheral Component Interconnect (PCI) bus.

9. The remotely manageable data processing system of claim 1, wherein the network packets utilize a platform independent protocol.

10. The remotely manageable data processing system of claim 1, wherein the network packets utilize a non-proprietary, open protocol.

11. The remotely manageable data processing system of claim 1, wherein the network packets utilize a protocol with video, mouse, and keyboard support.

12. The remotely manageable data processing system of claim 1, further comprising a local video adapter in communication with the video spoof subsystem, wherein the local video adapter receives the video data from the processing core via the video spoof subsystem.

13. The remotely manageable data processing system of claim 1, wherein:
the video data comprises digital video data;
the remotely manageable data processing system includes no video adapter; and
the remotely manageable data processing system does not convert the digital video data to analog.

14. A distributed computing system for remotely managing a data processing system, the distributed computing system comprising:
a remotely manageable data processing system that generates video data;
a remote workstation in communication with the remotely manageable data processing system to receive the video data; and
one video adapter, wherein the remote workstation includes the one video adapter, and the distributed computing system converts video data from the remotely manageable data processing system into analog form only after the video data is received by the remote workstation.

15. The distributed computing system of claim 14, further comprising one random access memory digital-analog converter (RAMDAC) that converts the video data into analog form, wherein the remote workstation includes the RAMDAC.

16. A method of facilitating remote management of a data processing system, the method comprising:
initiating a basic input/output system (BIOS) boot process in the data processing system;
loading a video BIOS extension from a video spoof subsystem into a random access memory (RAM) of the data processing system;
receiving video data from a processing core of the data processing system at the video spoof subsystem;
converting the video data into bitmaps;
loading the bitmaps into a video memory module of the video spoof subsystem;
converting the bitmaps from the video memory module into network packets; and
transmitting the network packets to a remote workstation, such that the data processing system uses spoofing to support remote video.

17. The method of claim 16, further comprising:
booting an operating system (OS) on the data processing system; and
transmitting one or more of the network packets to the remote workstation before booting the OS.

18. The method of claim 17, further comprising transmitting one or more of the outgoing network packets to the remote workstation after booting the operating system.

19. The method of claim 16, wherein the data processing system includes no video adapter, the method further comprising:
receiving the network packets at the remote workstation; and
generating an analog signal based on the video data only after receiving the network packets at the remote workstation, such that the video data is not converted into an analog signal in the data processing system.

20. The method of claim 16, further comprising:
receiving a network packet at the data processing system, wherein the network packet contains input for the data processing system;
forwarding the input to a mouse/keyboard (M/K) spoof subsystem of the data processing system;
converting the input from the network packet into a keyboard scan code; and
transmitting the keyboard scan code from the M/K spoof subsystem to a keyboard controller of the data processing system.
